(19) United States
(12) Patent Application Publication
(10) Pub. No.: US 2026/0012000 A1
(43) Pub. Date: Jan. 8, 2026

(54) ELECTRICAL DEVICE FOR PROTECTING AN ELECTRICAL POWER SUPPLY INSTALLATION

(71) Applicant: SAFRAN ELECTRICAL & POWER, Blagnac Cedex (FR)

(72) Inventors: Olivier DESHAYES, Blagnac Cedex (FR); Jérôme VALIRE, Blagnac Cedex (FR)

(73) Assignee: SAFRAN ELECTRICAL & POWER, Blagnac Cedex (FR)

(21) Appl. No.: 19/130,635

(22) PCT Filed: Nov. 16, 2023
(86) PCT No.: PCT/FR2023/051811

§ 371 Date: May 16, 2025

(30) Foreign Application Priority Data
Nov. 17, 2022 (FR) 2211944

(51) Int. Cl. H02H 3/08; B64D 25/00; H01H 39/00; H02H 1/00

(52) U.S. Cl. CPC H02H 3/08; B64D 25/00; H01H 39/006; H02H 1/0007

(57) ABSTRACT

An electrical device for protecting an electrical installation intended to be placed between a power supply and an electrical load, the device including: a power contactor comprising two contacts that are intended to be connected to the power supply; at least two Hall sensors configured to measure the electric currents at the input of the power contactor; an electrical precharging circuit intended to be placed between the power supply and the power contactor and connected to the electrical load; a relay configured to connect or disconnect the electrical precharging circuit; a pyrotechnic electrical cutoff device intended to be connected to the power supply and to the power contactor, and a controller configured to receive the measurements from the Hall sensors and to open or close the power contactor and the relay.

### TECHNICAL FIELD

This invention relates to the general field of protection of an electrical installation, and more specifically to the protection of a high-voltage DC power supply system.

### PRIOR ART

Platforms of electric Vertical Take-Off and Landing (eVTOL) aircraft, electric Conventional Take-Off and Landing (eCTOL) aircraft and small aircraft for short flights (Air Taxi) use a new form of electrical propulsion powered by high-voltage batteries. These high-voltage batteries, which contain large amounts of energy, generally have built-in electrical protection based on fuses to be able to break off the line in the event of a hard short-circuit, i.e. when the two short-circuited points touch one another directly. These fuses thus make it possible to protect the electrical source.

However, in the event of an overload or current flowing through a soft short-circuit, i.e. when the two short-circuited points are connected by an impedance-grounded medium, a first gray area exists between the protection provided by the fuses and that provided by a power contactor, in which the airplane wiring is not protected. There is also a second gray area in the event of very high short-circuit currents which can make the contactor levitate and damage it, and also limit the current flowing through the fuse, which delays its tripping.

Thus, the fuses and contactors usually present in high-voltage power supplies, for example based on high-voltage batteries, do not always protect the electrical installation located between the electrical source and the load.

It is therefore desirable to possess an electrical protection means making it possible to protect the electrical installation of power supply systems based on high-voltage DC batteries.

### SUMMARY OF THE INVENTION

The invention relates to an electrical device for the protection of an electrical installation intended to be placed between an electrical power supply and an electrical load, the electrical power supply comprising positive and negative terminals, the device comprising:
a power contactor comprising a first contact intended to be connected to the positive terminal of the electrical power supply and a second contact intended to be connected to the negative terminal of the electrical power supply;
at least two Hall effect sensors configured to measure the electrical currents flowing between the electrical power supply and the power contactor;
a pre-charging electrical circuit comprising input terminals intended to be placed between the electrical power supply and the power contactor and output terminals intended to be connected to the electrical load;
a relay configured to connect or disconnect the pre-charging electrical circuit;
a pyrotechnic electrical breaking device intended to be connected to the negative terminal of the electrical power supply and to the second contact of the power contactor, and
a controller configured to receive the electrical currents measured by the Hall effect sensors and to trigger an opening or closing of the power contactor and of the relay.

The pyrotechnic electrical breaking device, more commonly known as a pyrofuse, is capable of opening the power circuit by fuse effect when currents are high (for example for currents of up to 5 kA) or by mechanical breaking effect using the pyrotechnic actuator (present in the pyrofuse) for lower currents.

Thus, owing to the device of the invention, the combination of the pyrofuse and the power contactor makes it possible to open the power distribution line as soon as a short-circuit or an overload appears.

Specifically, in the event of an overload, for example when the current measured by the Hall effect sensors is between the nominal current and 1 kA), the fault current is seen via the current measurements made by the Hall effect sensor and the controller can command the opening of the contactor. Whereas in the event of a short-circuit, for example when the current measured by the Hall effect sensor is between 1 kA and 5 kA, it is the pyrofuse that will be opened to protect the electrical installation.

According to a particular feature of the invention, the device also comprises a fuse intended to be connected to the positive terminal of the electrical power supply and to the first contact of the power contactor.

This fuse makes it possible to have an additional protection of the electrical installation in the event of a significant short-circuit.

According to another particular feature of the invention, the device also comprises a magnetic probe, placed between the pyrotechnic electrical breaking device and the second contact of the power contactor, configured to detect a short-circuit and trigger the opening of the pyrotechnic electrical breaking device.

Another subject of the invention is a high-voltage DC power distribution board comprising the protection device according to the invention and an electrical circuit for energizing an electrical load.

Another subject of the invention is a method for controlling the electrical protection device according to the invention comprising:
the closing of the relay to connect the pre-charging circuit to the electrical load;
the closing of the power contactor;
the opening of the relay to make an electrical current flow from the electrical power supply to the electrical load, and
the measurement of an electrical current flowing through the protection device by the Hall effect sensors, the comparison of the measured electrical current to two predetermined thresholds and the opening of the power contactor if the measured current is between these two predetermined thresholds or the opening of the pyrotechnic electrical breaking device if the measured current is greater than the two predetermined thresholds.

According to a particular feature of the invention, the measurement of the electrical current flowing through the protection device is also performed by a magnetic probe.

Another subject of the invention is an aircraft comprising an electrical protection device according to the invention and/or a distribution board according to the invention.

### BRIEF DESCRIPTION OF THE DRAWINGS

Other features and advantages of this invention will become apparent from the description given below, with reference to the appended drawings which illustrate exemplary embodiments thereof without any limitation.

FIG. 1 represents, schematically and partially, the electrical protection device according to an embodiment of the invention.

FIG. 2 schematically represents a method for controlling the protection device of FIG. 1 according to an embodiment of the invention.

### DESCRIPTION OF THE EMBODIMENTS

In the description, the term “pyrofuse” refers to the pyrotechnic electrical breaking device.

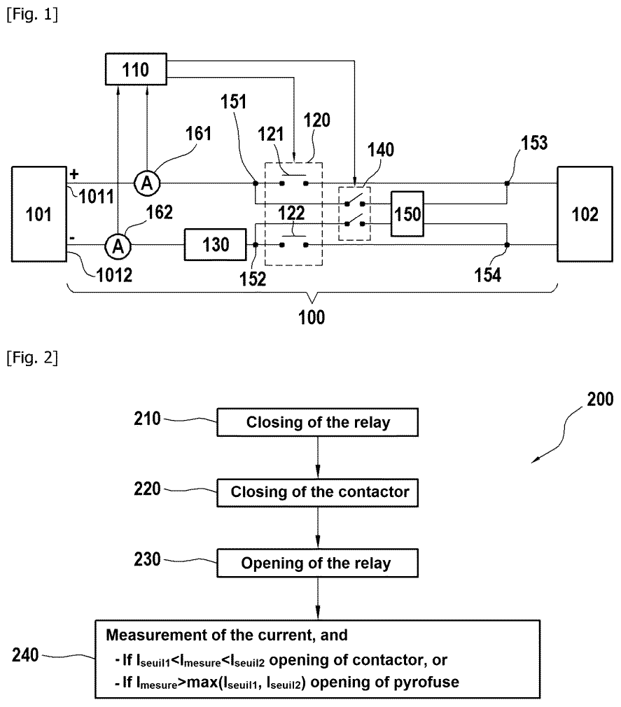

FIG. 1 represents, schematically and partially, an electrical protection device 100 according to an embodiment of the invention.

The device 100 makes it possible to electrically protect an electrical installation that might be placed between the positive 1011 and negative 1012 terminals of an electrical power supply 101 and an electrical load 102. The electrical installation that is being protected is formed of the device 100 and power harnesses connecting the electrical load 102 and the electrical power supply 101 to the device 100.

The device 100 comprises a power contactor 120, a pyrotechnic electrical breaking device 130, more commonly called a pyrofuse, two Hall effect sensors 161 and 162, a pre-charging circuit 150, a relay 140 and a controller 110.

The power contactor 120 comprises a first contact 121 which is connected to the positive terminal 1011 of the electrical power supply 101 and a second contact 122 which is connected to the negative terminal 1012 of the electrical power supply 101. It makes it possible to break the circulation of current between the electrical power supply 101 and the electrical load 102.

The Hall effect sensors 161 and 162 are configured to measure the electrical currents flowing between the electrical power supply 101 and the power contactor 120.

The pre-charging electrical circuit 150 comprises input terminals 151 and 152 which are placed between the electrical power supply 101 and the power contactor 120 and output terminals 153 and 154 which are connected to the electrical load 102. It makes it possible to limit the electrical current flowing toward the electrical load 102 before the closing of the power contactor 120.

The relay 140 is connected to the input terminals 151 and 152 of the electrical pre-charging circuit 150 to be able to connect it or disconnect it, i.e. to send it or not send it electrical current.

The pyrofuse 130 is connected to the negative terminal 1012 of the electrical power supply 101 and to the second contact 122 of the power contactor 120.

The controller 110 is configured to receive the current measurements from the Hall effect sensors 161 and 162 and to implement the method described with reference to FIG. 2, i.e. to trigger the opening or closing of the power contactor 120 and of the relay 140.

The device 100 may also comprise a fuse connected to the positive terminal 1011 of the electrical power supply 101 and to the first contact 121 of the power contactor 120. This fuse makes it possible to protect the electrical power supply 101 in the event of a high current, for example between 5 kA and 50 kA, and also to have a dissimilarity of the electrical protection of the power supply 101.

The device 100 can also comprise a magnetic probe, placed between the pyrofuse 130 and the second contact 122 of the power contactor 120. This magnetic probe makes it possible to detect a short-circuit and to trigger the opening of the pyrofuse 130 to protect the electrical installation. This makes it possible to have a fast and dissimilar current measurement with electronics of low complexity and to improve the safety of the device 100.

FIG. 2 represents, schematically and partially, a method 200 for controlling the protection device 100 of FIG. 1 according to an embodiment of the invention. The method 200 comprises the closing 210 of the relay 140 to connect the pre-charging electrical circuit 150 to the electrical load 102, then the closing 220 of the power contactor 120 to transmit the entire electrical power, and thus the entire electrical current, to the load 102, and then the opening 230 of the relay 140. The method 200 finally comprises the measurement 240 of the electrical current flowing through the protection device 100 using the Hall effect sensors 161, 162 and the comparison of the measured current Iₘₑₛᵤᵣₑ to two current thresholds Iₛₑᵤᵢₗ₁ and Iₛₑᵤᵢₗ₂ in order to open the power contactor 120 if the measured current Iₘₑₛᵤᵣₑ is between the two current thresholds Iₛₑᵤᵢₗ₁ and Iₛₑᵤᵢₗ₂ or to open the pyrofuse 130 if the measured current Iₘₑₛᵤᵣₑ is greater than the two current thresholds Iₛₑᵤᵢₗ₁ and ₛₑᵤᵢₗ₂.

The first current threshold Iₛₑᵤᵢₗ₁ is for example between the nominal current and 1 KA, and the second current threshold Iₛₑᵤᵢₗ₂ is for example between 1 kA and 5 kA. According to another example, the first current threshold Iₛₑᵤᵢₗ₁ is equal to the nominal current and the second current threshold Iₛₑᵤᵢₗ₂ is equal to 1 kA.

The electrical current measurement 240 can also be performed by a magnetic current probe placed between the pyrofuse 130 and the second contact 122 of the power contactor 120.

According to the embodiment of the device 100, the opening or closing of the pyrofuse 130, during the step 240, can be commanded in different ways:
by the controller 110;
by the magnetic current probe; or else
by a controller external to the device 100, which makes it possible to have control of the pyrofuse 130 independently of the device 100.

Consequently, if the pyrofuse 130 and the contactor 120 are both controlled by the controller 130 of the device, any opening of the pyrofuse 130 or of the contactor 120 will be commanded by the controller 130, as a function of the current values measured during the measurement and comparison step 240.

If the pyrofuse 130 is controlled by another control system than the controller 130, for example the magnetic probe, as described previously, or by a control system external to the device 100, then, during the step 240 of measurement and comparison with the thresholds Iₛₑᵤᵢₗ₁ and Iₛₑᵤᵢₗ₂, any opening of the contactor 120 will always be controlled by the controller 130 but any opening of the pyrofuse will be controlled by this external device or by the magnetic probe.

Another subject of the invention is a high-voltage DC power distribution board comprising the protection device of the invention and an electrical circuit for energizing an electrical load. The energizing electrical circuit is a pre-charging electronic system which makes it possible to charge the capacitances of the electrical loads at constant current, to avoid large current draws (current of a few kiloamperes) on the communication of the high-voltage DC (HVDC) power. This makes it possible to protect the loads on switching while being optimized for mass and volume by comparison with a conventional resistance system.

In the case of an aircraft with electrical propulsion, the board can thus be connected at its output terminals to the different electrical loads of the aircraft and at its input terminals to the electrical power supply sources of the aircraft. The electrical power supply source may for example be a high-voltage battery and the electrical load an electric motor.

It can also be connected to the global control system of the aircraft and to the emergency system of the aircraft. The pyrofuse can thus, for example, be controlled by the global system of the aircraft and by the emergency system.

In addition, the distribution board as described makes it possible to optimize the distribution of the electrical components of the protection device and of the energizing circuit as well as the different electrical protections of the components present on the board.

1. An electrical device for the protection of an electrical installation intended to be placed between an electrical power supply and an electrical load, the electrical power supply comprising positive and negative terminals, the device comprising:
a power contactor comprising a first contact intended to be connected to the positive terminal of the electrical power supply and a second contact intended to be connected to the negative terminal of the electrical power supply;
at least two Hall effect sensors configured to measure the electrical currents flowing between the electrical power supply and the power contactor;
a pre-charging electrical circuit comprising input terminals intended to be placed between the electrical power supply and the power contactor and output terminals intended to be connected to the electrical load;
a relay configured to connect or disconnect the pre-charging electrical circuit;
a pyrotechnic electrical breaking device intended to be connected to the negative terminal of the electrical power supply and to the second contact of the power contactor, and
a controller configured to receive the electrical currents measured by the Hall effect sensors and to trigger an opening or closing of the power contactor and of the relay.

2. The electrical protection device as claimed in claim 1, also comprising a fuse intended to be connected to the positive terminal of the electrical power supply and to the first contact of the power contactor.

3. The electrical protection device as claimed in claim 1, also comprising a magnetic probe, placed between the pyrotechnic electrical breaking device and the second contact of the power contactor, configured to detect a short-circuit and trigger the opening of the pyrotechnic electrical breaking device.

4. A high-voltage DC power distribution board comprising the protection device as claimed in claim 1 and an electrical circuit for energizing an electrical load.

5. A method for controlling the electrical protection device as claimed in claim 1 comprising:
the closing of the relay to connect the pre-charging circuit to the electrical load;
the closing of the power contactor;
the opening of the relay to make an electrical current flow from the electrical power supply to the electrical load; and
the measurement of an electrical current flowing through the protection device by the Hall effect sensors, the comparison of the measured electrical current to two predetermined thresholds and the opening of the power contactor if the measured current is between these two predetermined thresholds or the opening of the pyrotechnic electrical breaking device if the measured current is greater than the two predetermined thresholds.

6. The control method as claimed in claim 5, wherein the measurement of the electrical current flowing through the protection device is also performed by a magnetic probe.

7. An aircraft comprising an electrical protection device as claimed in claim 1 or a high-voltage DC power distribution board comprising the electrical protection device and an electrical circuit for energizing an electrical load.

8. An aircraft comprising an electrical protection device as claimed in claim 1 and a high-voltage DC power distribution board comprising the electrical protection device and an electrical circuit for energizing an electrical load.
